(19) United States
(12) Patent Application Publication
(10) Pub. No.: US 2015/0075012 A1
(43) Pub. Date: Mar. 19, 2015

(54) OUTIL A MAIN PERFECTIONNE

(71) Applicant: Opinel, Chambery (FR)

(72) Inventor: Denis OPINEL, Chambery (FR)

(21) Appl. No.: 14/477,443

(22) Filed: Sep. 4, 2014

(30) Foreign Application Priority Data
Sep. 5, 2013 (FR) 1358524

(51) Int. Cl. B26B 27/00; B26B 25/00; A47J 17/02

(52) U.S. Cl. CPC B26B 27/007; A47J 17/02; B26B 25/005
USPC 30/295

(57) ABSTRACT

A hand tool for cooking comprising a longitudinal handle (1), an active cutting part (2) comprising a cutting blade (7), characterized in that it comprises
a support zone (3B) for at least one finger of the user holding the handle, wherein the support zone extends substantially transversally to the handle, and
a finger protection zone (3C), wherein said protection zone is spaced from and opposite the supporting zone (3B), and located opposite the blade and opposite the handle and the support zone.

This invention relates to a hand tool, particularly for household use, and more particularly for use in the kitchen, and even more particularly for an operation consisting in finely slicing or peeling foodstuffs such as fruit and vegetables or for cutting pastry.

The invention will be particularly described by reference to a cutting utensil such as a vegetable peeler, without being limited to it. In particular, the invention also relates to a tool for cutting pastry, and generally any cutting tool for cooking, where cutting involves applying a pushing or pulling force along the longitudinal center line of the handle of the tool.

Such instruments are particularly known as peelers and comprise firstly a longitudinally directed handle that is held by the user in one hand, and an active part comprising at least one sharp blade placed opposite a strip known as a support strip parallel to the blade, wherein the sharp edge of the blade can be arranged in the active position below the plane formed by the blade and the support strip.

More particularly, and as an example and illustration, such a hand tool is known particularly for peeling fruit and vegetables and comprising, in the active part, an oblong element with a longitudinal direction orthogonal to that of the handle and substantially made up of a plate comprising a central longitudinal opening that separates the blade and the support strip.

In the active position, the user grasps the handle and applies the support strip on the surface of the fruit or vegetable, then pulls it towards him/herself along a plane tangential to the vegetable or fruit at the support strip, in the longitudinal direction of the handle. At the same time, the user preferably applies slight pressure on the fruit or vegetable, that is to say in the direction orthogonal to said tangential plane (and in the longitudinal direction of the handle).

As that happens, the blade penetrates or cuts the skin or the part to cut or peel, and the pulling makes the blade cut the peel to be removed, and makes the peel pass through the opening separating the support strip from the blade.

A pastry cutting utensil comprises a handle and a wheel-shaped cutting blade at one of its ends. The pastry is cut by holding the handle at an angle and applying pushing and/or pulling force (to-and-fro or otherwise) in the longitudinal direction of the handle, so as to maneuver the blade in a horizontal displacement movement on the pastry, thus cutting the pastry.

Such devices are sharp by definition and present risks and hazards, particularly for children and the vulnerable. In particular, the user tends to slide the index or another finger towards the blade when he/she takes back the tool or repositions his/her hand on it while cutting or when pushing force is applied on the tool in the direction of the blade.

However, the addition of a safety system, in a known manner, makes the tool larger, and in all cases makes it less handy.

Besides, depending on the fruit or vegetable or the operation required, particularly fine slicing, the force that needs to be applied along the tangential plane above, in the direction longitudinal to the handle, is not negligible and hand tools of the known type can be improved in that respect.

Lastly, the combination of the two forces, mainly the pulling force, with the other pressing down, presumes ad hoc balance between the two, which is not always easy with known hand tools of this type.

This invention remedies those drawbacks and discloses a hand tool especially for cooking, particularly intended for peeling or finely slicing foodstuffs such as fruit and vegetables, or cutting pastry, of the type with a longitudinal handle, an active cutting part comprising a cutting blade, characterized in that it comprises
a support zone for at least one finger of the user holding the handle, wherein the support zone extends substantially transversally to the handle, and
a finger protection zone, wherein said protection zone is spaced from and opposite the supporting zone, and located opposite the blade and opposite the handle and the support zone.

The support zone located between the active part of the tool and the handle is preferably integral with the end of the handle.

The tool thus makes it possible to grasp the tool, helps the pulling and/or pushing movement and thus cuts while providing a finger support and placing zone in the longitudinal center line of the handle, particularly at the end of the handle, while protecting the finger with the protection zone.

Advantageously, the support zone and the protection zone demarcate along the center line of the handle an intermediate part forming a hollow (hole) through which a finger of the user can pass.

Preferably, the support zone or surface for the finger allows the finger to apply force comprising at least one component along a direction co-linear or parallel to the longitudinal center line of the handle, in the direction opposite the blade.

In an advantageous alternative, said support zone for the finger is curved, with concavity turned towards the blade, and more particularly, the support zone is made in the form of a part of a cylinder with a center line transverse to the handle.

In order to make and manufacture the tool, the support zone and the protection zone demarcate an intermediate part between the active part and the handle, wherein the intermediate part is made up of a ring through which at least one finger of the user can pass, and the portion of the ring opposite the active part constitutes the finger protection zone.

The protection zone or the ring is joined opposite the handle to two branches spaced to form a sort of fork (or yoke) at the end of which is fixed the blade of the active part, wherein the branches extend in a main direction parallel to the center line of the handle.

Thus, the active part comprises a yoke with two branches, on which the cutting blade is mounted, wherein the end of the yoke opposite the blade is preferably integral with the protection zone.

In a particular application, the tool is used as a peeler, and comprises a yoke with two branches that extend in a main direction parallel to the center line of the handle and are arranged on either side respectively of the center line of the blade, wherein the blade is fixed to the free ends of the branches, transversally to the handle.

For a peeler, the blade is longitudinal and extends in a plane orthogonal to the handle. The active part also comprises a support strip that is parallel to said blade and separated from the blade by an oblong longitudinal space, wherein the support strip is designed to press against the item to cut.

In another application such as a utensil to cut pastry, the tool comprises a yoke with two spaced branches that extend along the center line of the handle, wherein the cutting blade takes the form of a wheel that is rotatably mounted between the two branches. The branches of the yoke extend along the center line of the handle and are spaced so that the spacing is just sufficient for accommodating the wheel, wherein the rotation axis of the wheel transversal to the branches is fixed at the ends of said branches.

Advantageously, the assembly made up of the support and protection zones (particularly the ring for passing the finger), the handle and at least one portion of the active part, particularly the yoke, are made in a single piece, preferably in metal or plastic material.

If plastic material is used, the piece is preferably made by molding.

When the support part of the handle is made of metal, that part of the handle is covered with a lightweight plastic sleeve designed for contact and for being grasped by the hand of the user.

The sleeve is fixed by rivets to the internal part of the handle.

The sleeve may also be made in wood, in two parts adapted to cover the internal part of the handle joined to the yoke.

For a peeler, the blade and the associated supporting strip are mounted to be mobile on the yoke, preferably mounted to rotate on an axis transversal to the center line of the handle and parallel to the blade, with rotation clearance of a few millimeters.

Lastly, for a peeler, means may be provided to block the rotation of the blade, in the form of stops allowing appropriate positioning of the blade inside the space demarcated between the two branches of the yoke in order to control the amplitude of the approach angle of the blade for peeling.

The assembly made up of the handle, yoke and ring for passing the finger is preferably made of reinforced plastic material, for example polypropylene (PP) or polyamide (PA) and glass fibers.

The invention will be better understood in the light of the description below of an exemplary embodiment of a hand tool by reference to the accompanying drawings wherein:

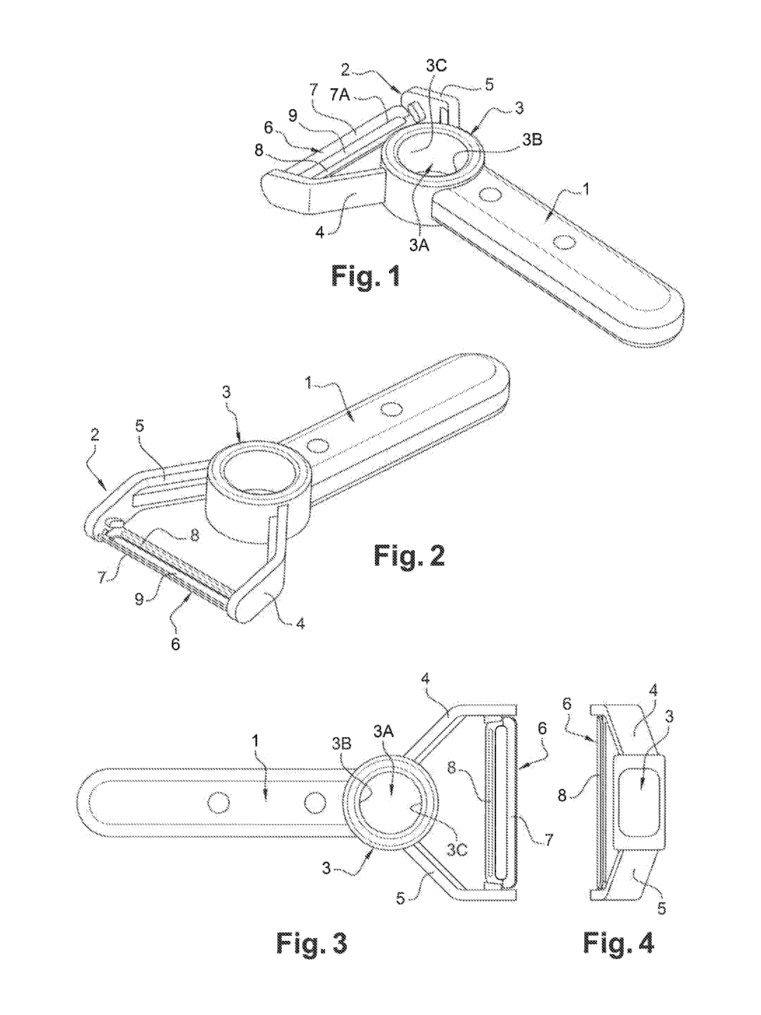

FIG. 1 is a rear perspective view of the tool according to the invention in an example of use as a peeler;

FIG. 2 is a front perspective view of the same tool;

FIG. 3 is a top view of the tool of FIGS. 1 and 2;

FIG. 4 is a front view of the same tool;

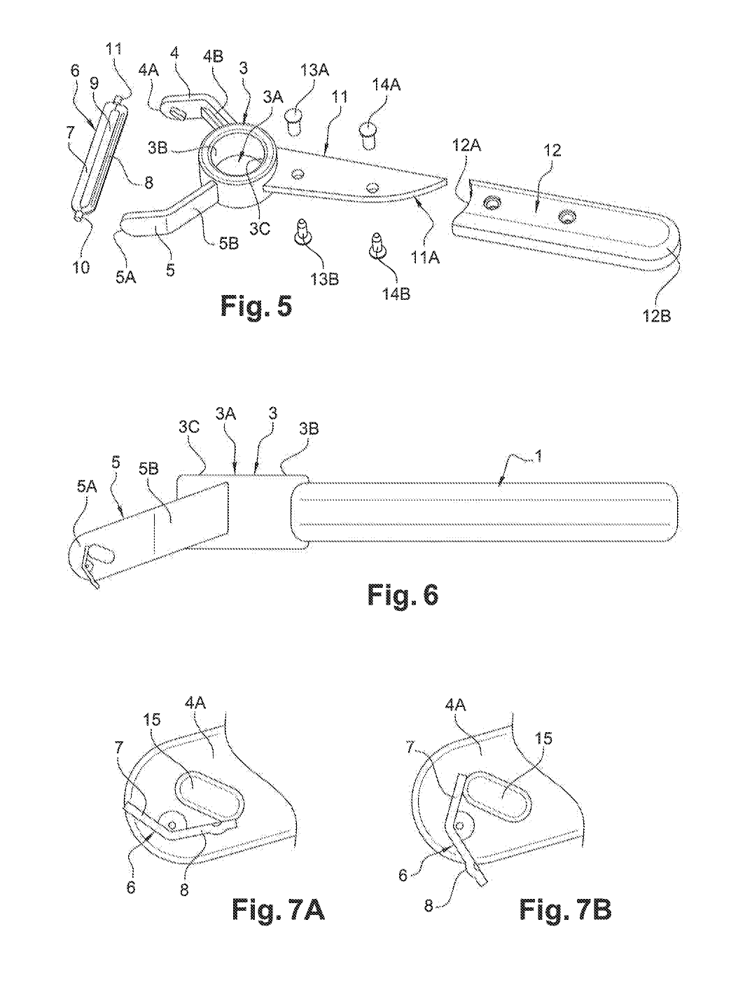

FIG. 5 is an exploded view of the different components shown in perspective of the tool of FIGS. 1 to 4;

FIG. 6 is a side view of the tool of FIGS. 1 to 4;

FIGS. 7A and 7B show a detailed side view of the end of one of the yokes seen from the inside, showing two positions of the working part 6.

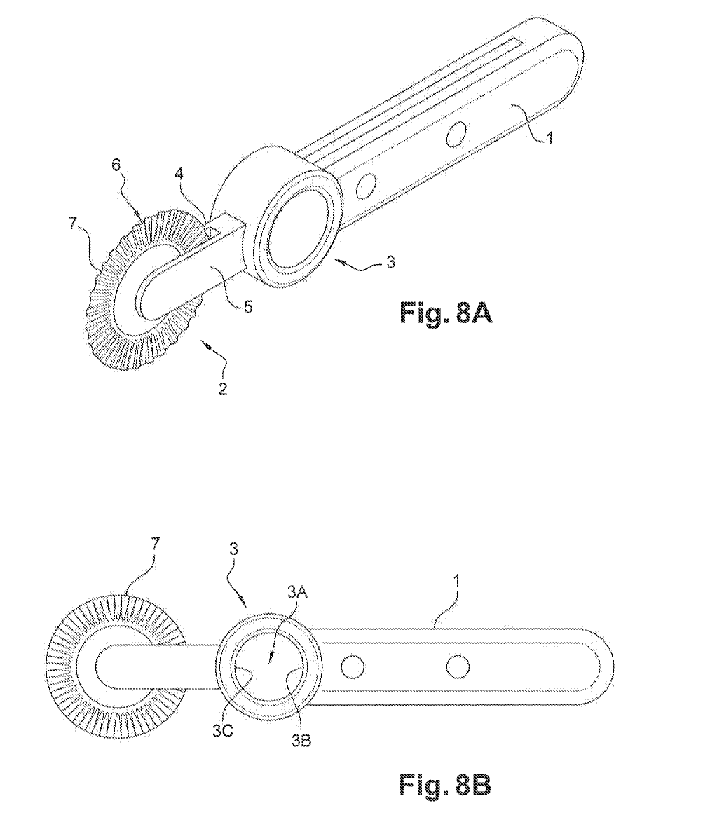

FIGS. 8A and 8B are perspective and side views respectively of another example of the tool according to the invention, in the form of a cutting tool for pastry.

FIGS. 1 and 2 are perspective views of the tool according to the invention, rear and front perspectives respectively, wherein the tool is used as a peeler as a non-limitative example.

In FIGS. 8A and 8B, the tool is used as a tool for cutting pastry, and the references of the different elements are the same. These figures are described later on.

The tool thus comprises several parts, namely a longitudinal handle 1, at one end of which is associated an active part 2 of the tool and an intermediate element 3 between the handle and the active part 2 in the shape of a cylindrical ring as explained below.

The active part 2 itself includes a yoke comprising two branches 4 and 5, one end of which is fixed to the ring 3 and the other free end is associated with a working part 6 designed to finely slice or peel foodstuffs such as fruit or vegetables particularly, or to cut pastry.

By reference to FIGS. 1 and 2, the part 6, hereinafter called the working part, is made up in a known manner of a blade 7 with a sharp edge 7A having a center line transversal to the handle and connecting the two ends of the yoke. The sharp part 7A of the blade 7 is turned towards the handle.

The working part 6 further comprises, in a known manner and in a preferred embodiment, a strip 8 known as the support strip, parallel to the cutting blade 7.

More particularly, in an advantageous form, the working part 6 is made up of a single oblong plate comprising an oblong central hole or opening 9, on each side of which are placed the blade 7 and the strip 8.

The respective planes of the blade 7 and the support strip 8 have an angular offset so that the sharp edge 7A of the blade is placed below the support strip 8 in relation to a plane passing through the support strip 8 and the distal end of the handle.

FIGS. 3 and 4 contain most of the elements and parts of FIGS. 1 and 2, bearing the same references.

The working part 6, 7 and 8 is preferably in stainless steel.

FIG. 5 is an exploded perspective view of the hand tool of FIGS. 1 to 4, particularly its different components.

Thus, in a preferred embodiment the tool comprises:
The working part 6 described above comprising the blade 7 and the support strip 8 and also two end pins 10 and 11.
The yoke formed by the branches 4 and 5, which are spaced and extend in a main direction parallel to the longitudinal center line of the handle and on each side of said handle.
The intermediate central part 3 in the shape of a cylindrical ring.
A flat or a rigid longitudinal blade 11, fixed to or integral with the intermediate ring 3, on the side opposite the branches of the yoke 4, 5.
A jacket 12 capable of covering the blade 11 and forming a sleeve, wherein the assembly made up of the flat and the sleeve forms the handle 1 of the tool.

Said blade 11 forms the core of the handle 1 and comprises, in the form of embodiment shown, a free end 11A shaped in an arc.

Each branch 4, 5 of the yoke is bent and comprises:
a first part 4B, 5B fixed at an angle so as to together form a Vee, on the cylindrical ring 3, and
a second part 4A with a center line parallel to the longitudinal center line of the handle.

The end parts 4A and 5B of each branch 4, 5 have a hole or opening that can be associated with the pins 10 and 11 of the working part 6 so as to allow that part to be fixed, while allowing the part to rotate slightly from about a few degrees to a maximum of 15° degrees in relation to the branches 4 and 5.

The proximal end 12A of the sleeve 12 is designed to stop against the exterior wall of the cylindrical ring 3 and thus comprises a complementary shape. The other distal end 12B of the sleeve is rounded for safety reasons. The sleeve 12 may be made of plastic or wood.

The jacket 12 is fixed to and made integral with the blade 11 by means of two rivets 13A, 13B and 14A, 146.

FIG. 6 contains the elements and parts shown in FIGS. 4 and 5, bearing the same references.

FIG. 6 shows that the yokes 4 and 5, in this case the visible yoke 5, is placed in a slanting manner in relation to the plane defined by the handle 1 and the intermediate annular part 3, which makes it possible to place the blade 7 below the handle in the active position of use of the tool.

FIGS. 7A and 7B show a side view, from the inside, of the end 4A of the yoke 4, showing the working part 6 mounted to rotate on said end 4A and to move rotationally between the two positions shown in FIGS. 7A and 7B respectively.

The edge of the distal end of the blade 7, opposite the sharp side 7A and thus opposite the median opening 9, is adapted to stop against a pin 15 protruding inward, provided on the branch 4A, 5A. The pins 15 of the branches supporting the blade make it possible to control the rotation of the blade and its approach angle during use.

When the tool according to the invention is used, the user grasps the handle 1 in one hand, passes one of his/her fingers, preferably the index finger, in the hole 3A of the intermediate cylindrical ring 3.

The user then places the tool on the fruit to treat (not shown), with the handle 1 and the ring 3 in the same substantially horizontal plane.

The tool is supported by the fruit or vegetable through the support strip 8, while the blade 7 begins to penetrate the skin or the surface part of the fruit or vegetable.

Holding the fruit in the other hand or by any other means, the user then applies a pulling force in the plane of the handle and in the direction of the handle, opposite the blade, that is the user pulls it towards him/herself, making the active part 7A penetrate into the fruit, and thus lifts up the surface part of the skin or the part of the fruit to remove or a fine slice of the fruit, which passes through the central oblong opening 9 and is either a peel or the fine slice required.

In that way, the user also applies additional, but less intense force in a direction orthogonal to the tangential plane of contact between the fruit and the support strip 8 or along the longitudinal center line of the handle 1.

The direction of that additional effort may also be defined as orthogonal to the plane defined by the handle 1 and the intermediate ring 3.

The pulling force applied by the user in the plane of the handle is strongly assisted by or even chiefly comes from the support of the finger passing through the hole 3A of the part 3, in its part 3B close to the handle; this support part is the arc of a cylinder with concavity turned towards the working part 6.

The fact that the central part 3 has a closed (cylindrical) shape keeps the finger protected.

By reference to FIGS. 8A and 8B, the tool is designed for another type of cutting, namely cutting pastry, where only the active part 2 differs from that of the peeler.

The pastry cutting tool according to the invention comprises a longitudinal handle 1 and a finger support part 3B close to the handle and substantially transversal to it; that part extends along a line that is preferably closed in the shape of a hollow annual part 3 to advantageously allow the finger to pass through the hole 3A and keep it protected by the protection zone 3C.

The working part 6 of the pastry cutting tool takes the form of a wheel, with a blade 7 that is advantageously serrated here. The working part 6 is mounted on a yoke with two branches 4 and 5, wherein the shape and arrangement of said branches are different from those of the peeler.

In a known manner, the branches 4 and 5 are oblong and extend along the longitudinal center line of the handle. The branches are spaced to accommodate the wheel 6 rotatably mounted between said branches and fixed at the ends of those branches.

1. A hand tool for cooking comprising a longitudinal handle (1), an active cutting part (2) comprising a cutting blade (7) placed opposite a strip known as a support strip (8), parallel to the blade, wherein the sharp edge of the blade (7A) can be arranged, in the active position, below the plane formed by the blade (7) and the support strip (8), the blade (7) extends substantially transversally to the handle (1), the tool comprises a support zone (3B) for at least one finger of the user holding the handle, wherein the support zone extends substantially transversally to the handle, characterized in that it also comprises a finger protection zone (3C) and in that the support zone (3B) and the protection zone (3C) demarcate an intermediate part (3) between the active part (2) and the handle (1), wherein the intermediate part (3) is made up of a ring through which at least one finger of the user can pass, and the portion of the ring opposite the active part constitutes the finger protection zone.

2. The hand tool according to claim 1, characterized in that the support zone (3B) allows the finger to apply force comprising at least one component along a direction co-linear or parallel to the longitudinal center line of the handle, in the direction opposite the blade.

3. The hand tool according to claim 1, characterized in that the support zone (3B) for the finger is curved, with concavity turned towards the blade (7).

4. The hand tool according to claim 1, characterized in that the support zone (3B) is made in the form of a part of a cylinder with a center line transverse to the handle.

5. The hand tool according to claim 1, characterized in that the active part (2) comprises a yoke with two branches (4, 5) on which the cutting blade (7) is mounted, wherein the end of the yoke opposite the blade is preferably integral with the protection zone (30).

6. The hand tool according to claim 1, characterized in that it forms a peeler and comprises a yoke with two branches (4, 5) that extend in a main direction parallel to the center line of the handle and are arranged on either side respectively of the center line of the blade, wherein the blade (7) is fixed to the free ends of the branches, transversally to the handle (1).

7. The hand tool according to claim 1, characterized in that it forms a tool to cut pastry and comprises a yoke with two spaced branches (4, 5) that extend along the center line of the handle, wherein the cutting blade (7) takes the form of a wheel that is rotatably mounted between the two branches (4, 5).

8. The hand tool according to claim 1, characterized in that the support zone (3B), the protection zone (30), the handle (1) and at least one portion of the active part (2) are made in a single piece, preferably in metal or plastic material.
